(19) United States
(12) Patent Application Publication
(10) Pub. No.: US 2015/0088917 A1
(43) Pub. Date: Mar. 26, 2015

(54) RESPONSIVE USER INTERFACE RENDERING BASED ON VELOCITY

(71) Applicant: fisoc, Inc., Austin, TX (US)

(72) Inventors: Daniel Edward Kim, Austin, TX (US); David H. Fruhling, II, Austin, TX (US); Jay P. Valanju, Austin, TX (US); Brian Rainey, Austin, TX (US)

(21) Appl. No.: 14/300,265

(22) Filed: Jun. 10, 2014

Related U.S. Application Data
(60) Provisional application No. 61/882,141, filed on Sep. 25, 2013.

(51) Int. Cl. G06F 17/30; H04W 4/02; H04L 12/24

(52) U.S. Cl. CPC G06F 17/30979; H04L 41/22; H04W 4/027; G06F 17/30061
USPC 707/758

(57) ABSTRACT

Content is rendered based on a measured velocity of an internet capable mobile device (ICMD). The ICMD accesses a database of content, and a user interface is activated for searching the database of content. After determining a current velocity of the ICMD, customized content based on search parameters input via the user interface and based on the current velocity of the ICMD is rendered.

### CROSS-REFERENCES TO RELATED APPLICATIONS

This application claims the benefit of U.S. Provisional Patent Application Ser. No. 61/882,141, filed Sep. 25, 2013, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to rendering content on an internet capable mobile device and, more particularly, rendering content based on a velocity of the device.

With reference to FIG. 1, internet capable mobile devices (ICMDs) 100 can be used in many contexts. Activating a device while stationary may imply a different desired use-case than if activating a device while moving. An example is an application that contains geographic points. While stationary, the user accessing the device is likely to be in an exploratory use case (like finding a place to visit). While moving, the user is likely wanting to engage in a transactional use case (finding out how to get there or progress in the journey). When moving, it may be unsafe to use device search capabilities (like while in a car).

### BRIEF SUMMARY OF THE INVENTION

Depending on measured velocity, the system acts dynamically to present the best use-case to the user. For example, for a mobile rewards program, when stationary, activating the interface could bring up the user's point balance 200 (FIG. 1). The user would be able to drill down into a merchant directory as normal. If the system detects movement implying car velocities, the system could bring up the detailed view of the last merchant seen, or if too much time has elapsed, the system could bring up a map view 300 (FIGS. 2 and 3) of merchants close to the user.

In an exemplary embodiment, a method of rendering content is based on velocity using an internet capable mobile device (ICMD). The method includes the steps of (a) the ICMD accessing with communication hardware or storing with an onboard memory a database of content; (b) activating a user interface for searching the database of content; (c) determining a current velocity of the ICMD with hardware in the ICMD; and (d) rendering customized content based on search parameters input via the user interface and based on the current velocity of the ICMD.

Step (b) may include a user accessing the user interface, and the user inputting the search parameters. The ICMD may include a processor, and step (b) may further include the processor inputting the search parameters based on a previous search.

Step (d) may be practiced by rendering information dense detailed content when it is determined in step (c) that the current velocity of the ICMD is below a threshold, and rendering quick view content when it is determined in step (c) that the current velocity of the ICMD is above the threshold. In this context, the information dense detailed content may include all relevant content in the database, where the quick view content includes routing instructions.

When it is determined that the current velocity of the ICMD is greater than zero, the method may further include determining a direction in which the ICMD is moving, and step (d) may be practiced by refining the customized content based on the direction.

Button responses may be varied within the customized content according to the velocity.

In another exemplary embodiment, a computer program stored on a non-transitory computer medium is executed by a processor of an internet capable mobile device (ICMD) to perform the steps of the method. When it is determined in step (c) that the ICMD is stationary, step (d) may be practiced by rendering all relevant content in the database, and when it is determined in step (c) that the ICMD is moving at a velocity above a threshold velocity, step (d) may be practiced by rendering limited relevant content. Multiple threshold velocities may be defined, and step (d) may be practiced by rendering a continuously responsive design based on the current velocity relative to the multiple threshold velocities.

In yet another exemplary embodiment, an internet capable mobile device (ICMD) renders content based on velocity. The device includes a processor, communication hardware and an onboard memory communicating with the processor, and a user interface. The ICMD accesses a database of content via the communication hardware or stores the database of content in the onboard memory. The device includes hardware for determining a current velocity of the ICMD and a display communicating with the processor. The processor renders customized content on the display based on search parameters input via the user interface and based of the current velocity of the ICMD.

### BRIEF DESCRIPTION OF THE DRAWINGS

These and other aspects and advantages will be described in detail with reference to the accompanying drawings, in which:

FIG. 1 is an exemplary view of a rewards program point balance;

FIG. 2 is an exemplary screen showing nearby merchants;

FIG. 3 is an exemplary screen shot with information dense detail;

FIG. 4 is an exemplary screen showing routing instructions to a destination; and

FIG. 5 is a flow chart of the system operation.

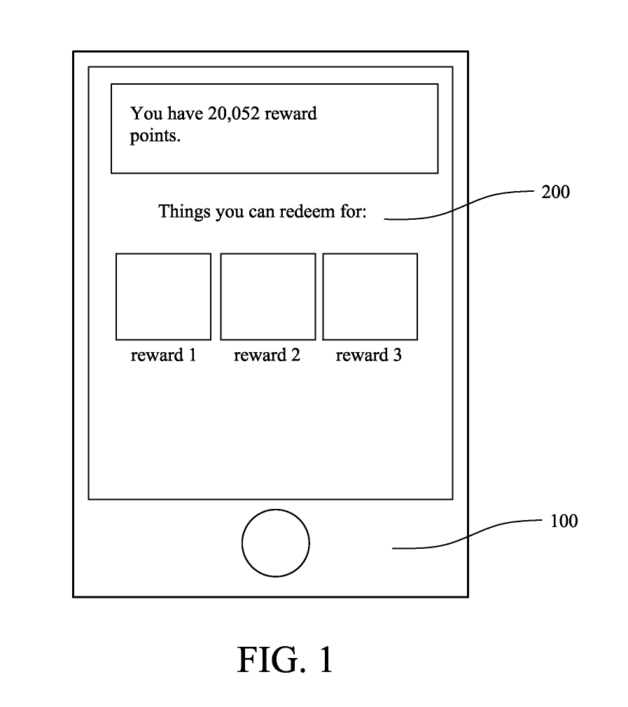

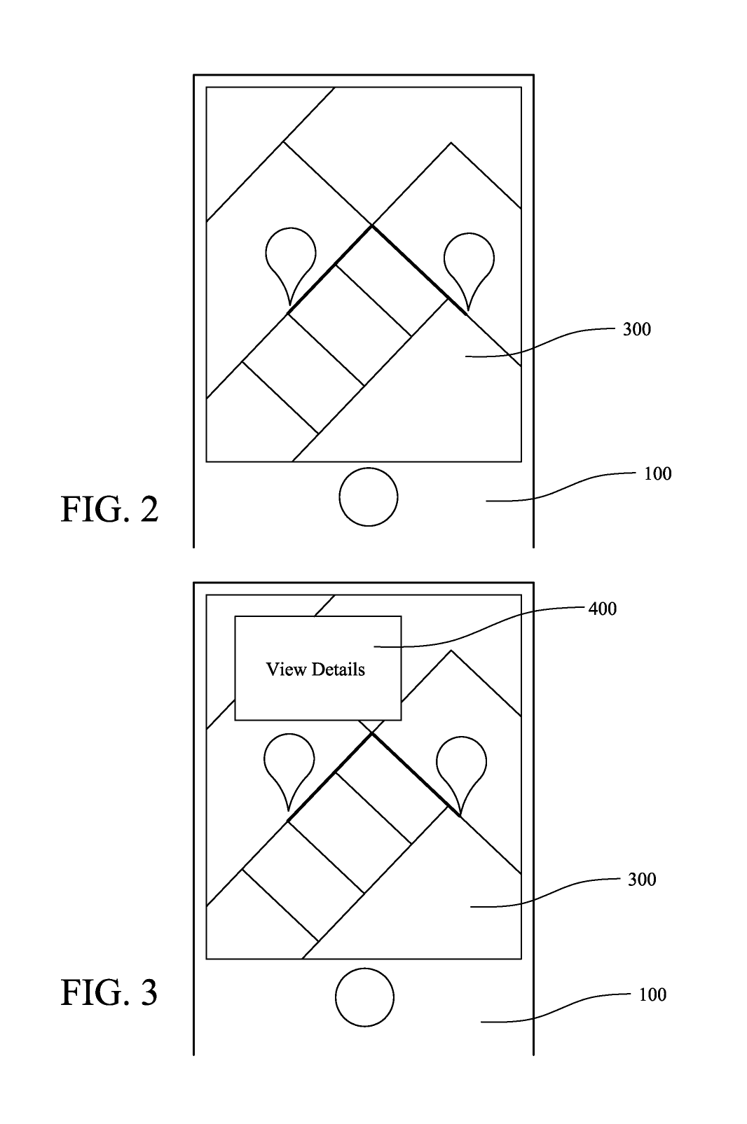

### DETAILED DESCRIPTION OF THE INVENTION

An ICMD comprises a display, a microphone, a speaker, a camera, a high speed transmit/receive device, such as a modem, in addition to a full function keyboard. The display may be touch enabled, touch sensitive, or a touch screen. The device may be multi-touch enabled. The ICMD may have various icons, keys, on-screen keyboards, virtual keyboards, international keyboards, and other aspects which may be integrated into the operating system or downloaded and modified by a server. The ICMD may have additional input/output ports for plugging in auxiliary devices such as a printer, and other devices through either wired or wireless means. The ICMD has a transmitter, receiver, a digital signal processor, other processors, a controller, display electronics and audio/video electronics. These functional blocks may be implemented using standard electronic, mechanical, or electromechanical components or custom electronic, mechanical, or electromechanical components by those knowledgeable in the art.

The ICMD is able to leverage the computing power of a global network or local server to process data. The ICMD serves as a transmit and receive hub. Thus, the ICMD is able to access a network or local server or an intelligent peripheral device to perform any operation or function.

The ICMD is able to transmit data input by a user to the network or local server or other devices for further processing. A user may input data into the ICMD by typing on the keyboard, inputting voice or sound through the ICMD's speaker, touching the screen of the display on the ICMD, using a mouse that interfaces with the ICMD, using a pen that interfaces with the ICMD, or through another method or device that interfaces with the ICMD. This data and commands generated by the ICMD may be sent to the local network server or other devices for further processing. The ICMD is able to retrieve data processed by the local or network server or other devices. The ICMD can then perform further processing or output this data through the display, the speaker, or another device that interfaces with the ICMD.

The ICMD may be configured with several wired and wireless transmit and receive components including, without limitation, 4G, Long term evolution (LTE), 3G, 2G, CDMA, WiMax, NFC, RFID, Global Positioning System (GPS), WiFi, IEEE 802.11a,b,c,n (or any variant), Bluetooth, Zigbee, spread-spectrum, direct sequence spread spectrum (DSSS), frequency division multiplexing (FDM), Orthogonal FDM (OFDM), Ethernet, cable, telephone, USB 1.0, USB 2.0, USB 3.0 or other wired or wireless means. The ICMD may operate on a plurality of frequencies, communication bands, and channels. The ICMD may access location based services. The ICMD may be configured with various software applications that may be run on a server as a software service or are downloaded from the server. Further details relating to the ICMD hardware and software are known and will not be further described.

With reference to FIG. 5, when an interface is presented on the device, the device will measure the current speed and direction of the user (step 600). The device will make a determination based on speed if the user needs to quickly glance at an item or if the user wants to explore the interactions surfaced by the interface. This determination is made by comparing the measured speed to a configurable speed threshold. There can be multiple thresholds to implement a continuously responsive design based on speed.

Once the correct view has been determined, other information like direction and previous interactions are used to surface and refine the view. Based on this information the selected view can be modified. As an optimization, this consideration can be combined with the first step (step 610).

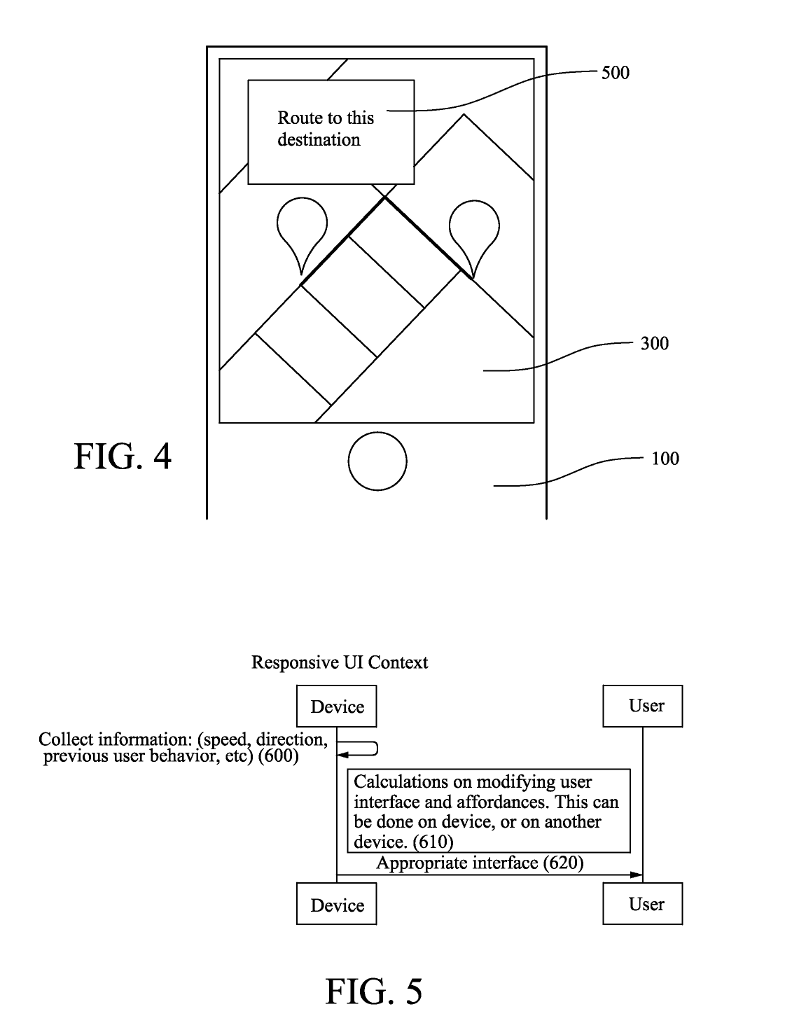

The velocity and previous behavior appropriate view is surfaced to the user (step 620). User actions such as button responses can also be modified in a similar capacity. An example of this would be drilling down into a merchant. When the user is stationary, an information dense detail view 400 can be presented (FIG. 3). While moving at sufficient velocity, that same user interaction would effect a different response such as computing routing instructions to the destination 500 (FIG. 4). One practical implementation of this is to increase the size of buttons. For example, if a user is trying to use a phone in a car in motion, which is inappropriate and unsafe, the most important actions can be made bigger (expansion of the click area) dependant on speed. As a result, if a user absolutely must look at their phone while driving, the larger buttons or click area will enable any actions to be conducted more quickly. If the user is at a stand still, the click area can be much smaller because the user can pay much more attention to the screen.

These computations can be done either on the client device or on a remote computing device such as a server. In peer to peer use cases, the client may synchronize with another client to collaborate to present the best use case.

In use, an internet capable mobile device (ICMD) accesses a database of content. The ICMD may access the database with communication hardware on the device, or the database of content may be stored in an onboard memory. A user interface is activated for searching the database of content, and a current velocity of the ICMD is determined using hardware on the ICMD. Based on search parameters input via the user interface and based on the current velocity of the ICMD, customized content is rendered. In one arrangement, the user accesses the user interface, and the user inputs the search parameters. Alternatively or additionally, the processor may input the search parameters based on a previous search. The customized content includes information dense detailed content when it is determined that the current velocity of the ICMD is below a threshold. Similarly, quick view content, which includes less information than the information dense detailed content, and typically amounts to content that can be viewed quickly or instantly, is rendered when the current velocity of the ICMD is above the threshold. In an exemplary application, the information dense detailed content includes all relevant content in the database, and the quick view content includes routing instructions.

When it is determined that the current velocity of the ICMD is greater than 0 (i.e., the ICMD is in motion), the system may determine a direction in which the ICMD is moving. In this context, the customized content may be further refined based on the direction in which the ICMD is moving. The system acts dynamically depending on measured velocity to present the best use-case to the user. With a stationary device, all relevant database information may be displayed for the user. If the system detects movement implying car velocities or the like, the system may bring up a detailed view of the last merchant seen or otherwise render quick view content that can be easily and quickly observed by the user.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of rendering content based on velocity using an internet capable mobile device (ICMD), the method comprising:
(a) the ICMD accessing with communication hardware or storing with an onboard memory a database of content;
(b) activating a user interface for searching the database of content;
(c) determining a current velocity of the ICMD with hardware in the ICMD; and
(d) rendering customized content based on search parameters input via the user interface and based on the current velocity of the ICMD.

2. A method according to claim 1, wherein step (b) comprises a user accessing the user interface, and the user inputting the search parameters.

3. A method according to claim 2, wherein the ICMD includes a processor, and wherein step (b) further comprises the processor inputting the search parameters based on a previous search.

4. A method according to claim 1, wherein the ICMD includes a processor, and wherein step (b) comprises the processor inputting the search parameters based on a previous search.

5. A method according to claim 1, wherein step (d) is practiced by rendering information dense detailed content when it is determined in step (c) that the current velocity of the ICMD is below a threshold, and rendering quick view content when it is determined in step (c) that the current velocity of the ICMD is above the threshold.

6. A method according to claim 5, wherein the information dense detailed content includes all relevant content in the database, and wherein the quick view content includes routing instructions.

7. A method according to claim 1, wherein when it is determined that the current velocity of the ICMD is greater than zero, the method further comprises determining a direction in which the ICMD is moving, and step (d) is practiced by refining the customized content based on the direction.

8. A method according to claim 1, further comprising varying button responses within the customized content according to the velocity.

9. A method according to claim 8, wherein the step of varying button responses comprises increasing button size according to the velocity.

10. A computer program stored on a non-transitory computer medium, the computer program being executed by a processor of an internet capable mobile device (ICMD) to perform the steps of:
(a) accessing a database of content;
(b) activating a user interface for searching the database of content;
(c) determining a current velocity of the ICMD with hardware in the ICMD; and
(d) rendering customized content based on search parameters input via the user interface and based on the current velocity of the ICMD.

11. A computer program according to claim 10, wherein when it is determined in step (c) that the ICMD is stationary, step (d) is practiced by rendering all relevant content in the database, and wherein when it is determined in step (c) that the ICMD is moving at a velocity above a threshold velocity, step (d) is practiced by rendering limited relevant content.

12. A computer program according to claim 11, further comprising defining multiple threshold velocities, wherein step (d) is practiced by rendering a continuously responsive design based on the current velocity relative to the multiple threshold velocities.

13. A computer program according to claim 10, wherein the search parameters are defined according to a previous search.

14. A computer program according to claim 10, wherein when it is determined that the current velocity of the ICMD is greater than zero, the computer program is executed to determine a direction in which the ICMD is moving, and step (d) is practiced by refining the customized content based on the direction.

15. An internet capable mobile device (ICMD) for rendering content based on velocity comprising:
a processor;
communication hardware and an onboard memory communicating with the processor, the ICMD accessing via the communication hardware or storing in the onboard memory a database of content;
a user interface for searching the database of content;
hardware in the ICMD for determining a current velocity of the ICMD; and
a display communicating with the processor, the processor rendering customized content on the display based on search parameters input via the user interface and based on the current velocity of the ICMD.

16. An ICMD according to claim 15, wherein the processor is programmed to receive the search parameters by user input on the user interface.

17. An ICMD according to claim 15, wherein the processor is programmed to automatically input the search parameters based on a previous search.

18. An ICMD according to claim 15, wherein the processor is programmed to render information dense detailed content when it is determined that the current velocity of the ICMD is below a threshold, and to render quick view content when it is determined that the current velocity of the ICMD is above the threshold.

19. An ICMD according to claim 15, wherein when it is determined that the current velocity of the ICMD is greater than zero, the processor is programmed to determine a direction in which the ICMD is moving, and to refine the customized content based on the direction.
